(19) United States
(12) Patent Application Publication
(10) Pub. No.: US 2002/0120788 A1
(43) Pub. Date: Aug. 29, 2002

(54) Method and system of activating computer peripherals by processed messages in real time

(76) Inventors: Douglas W. Wang, Hsinchu (TW); Wei-Shang Chen, Taichung (TW); Jack Chang, Tainan Hsien (TW); Chao-Yueh Huang, Kaohsiung (TW)

Correspondence Address: NATH & ASSOCIATES, 1030 15th STREET, 6TH FLOOR, WASHINGTON, DC, 20005, US

(21) Appl. No.: 09/824,736

(22) Filed: Apr. 4, 2001

(30) Foreign Application Priority Data
Feb. 23, 2001 (TW) 90104275

(51) Int. Cl. G06F 9/46

(52) U.S. Cl. 709/318

(57) ABSTRACT

A method and system may process messages in real time. The computer may analyze the received message in advance when receiving a message from the sender, which means the computer may determine whether or not the received message is the specific message which needs to be processed in real time. If the received message is specific, then, according to the setting reminding method, the system may utilize shaking of the mouse, sending out voice or light or displaying an image on the screen to remind the users. The users thus may respond to the message immediately, which may eliminate the delay of the important message.

### FIELD OF THE INVENTION

This invention relates to a method and a system to real time process message, and specifically relates to a method and system for utilizing received messages to trigger a real time responding system.

### BACKGROUND OF THE INVENTION

It has become an important tool for users handling routing work to utilize a computer through the Internet to search and download information, receive and send mails, deal on line, and store their personal schedule. Therefore, many important messages are transmitted and stored by computers. However, users often miss some important business messages or business meetings because they have forgotten to check their e-mail and their schedule stored in the computer as a result of being busy. The users have to check their e-mail often when waiting for important e-mails, which may interrupt the users work. The user must also check their schedule on the computer themselves, as the computer may not remind the users about what they need to do. This may reduce the practicability of the system.

Although the operating system of many communication systems all contain the message driving function, showing a reminding screen on the display when receiving a message. Different operating systems require a different driver to trigger the message driving function, sound, and reminding screen are used to remind the users traditionally. For example, the typically reminding method of e-mail management systems is to show a “mail received” message on the screen or to send out a voice to remind the users an e-mail has been received. However, at this point, it is uncertain whether or not the received e-mail is the mail the user has been waiting to receive. The conventional reminding method does not support the function of letting the users add a specific e-mail address by themselves. The reminder screen does not tell the users who sent the message. In other words, the conventional reminding method only tells users an e-mail has been received. Users must check the e-mail management system to know who sent the e-mail and then the users can determine whether or not the received e-mail is the mail they were waiting to receive. Therefore, that is a weakness of the conventional reminding method.

Furthermore, the voice and reminding screen are usually used as reminding tools in the conventional reminding method. These kinds of reminding tools can be accepted when the users are in personal room. However, if the users are in a public place, these reminding tools may not protect personal information well. Therefore, the need exists for a new method of reminding that has privacy protection and may provide an effective reminding function.

### SUMMARY OF THE INVENTION

According to the background of the invention, it is therefore an objective of the present invention to provide a method and a system of real time processing message. The method may provide the users real time reminding through predetermining the personal schedule, e-mail address, and on line communication they want to receive or want to say, which may eliminate the inconvenience of checking the personal schedule management system, e-mail management system, and on-line communication management system.

It is another objective of the present invention to provide a kind of private reminding method. The method provides the function for users to set real time reminding by themselves under this kind of circumstance and not to interrupt another person.

According to the above objectives, the present invention discloses a method for processing messages in real time. The computer may analyze the received message in advance when receiving a message from the sender, which means the computer may determine whether or not the received message is the specific message which needs to be processed in real time. If the received message is specific, then, according to the setting reminding method, the system may utilize shaking of the mouse, sending out voice or light or displaying an image on the screen to remind the user. The user thus may respond to the message immediately, which eliminates important message delays.

According to the disclosed method of the present invention, it is different from the conventional method that only provides users with a message telling them a message has been received, but it does not provide the name or e-mail address of the person who sent the message and whether or not it is the message the user has been waiting to receive. The present invention may also provide the reminding of schedule, which avoids the possibility of missing something scheduled that is important.

### BRIEF DESCRIPTION OF THE DRAWINGS

For a more complete understanding of the invention, references are made to the following Detailed Description of the Preferred Embodiment taken in connection with the accompanying drawings in which:

FIG. 1 is a block diagram illustrating a real time processing message system of the present invention;

FIG. 2 is a flow chart illustrating the setting event process of the present invention;

FIG. 2A is a flow chart illustrating the setting process of hot key of the present invention;

FIG. 3 is a flow chart illustrating the checking event process of the present invention;

FIG. 4 shows an interface illustrating the specific e-mail being checked by the present invention; and

FIG. 5 shows an interface illustrating the specific schedule being checked by the present invention

### DETAILED DESCRIPTION OF THE PREFERRED EMBODIMENT

Without limiting the spirit and scope of the present invention, the method proposed in the present invention is illustrated with one preferred embodiment about the real time processing message. People who are knowledgeable about the embodiments can apply the present invention to different reminding systems to eliminate the possibility of missing a meeting, due to forgetting to check the schedule on the computer, and to eliminate the disadvantage of repeatedly checking the e-mail management system when waiting for an important e-mail. The usage of the present invention is not to be limited by the embodiment as follows.

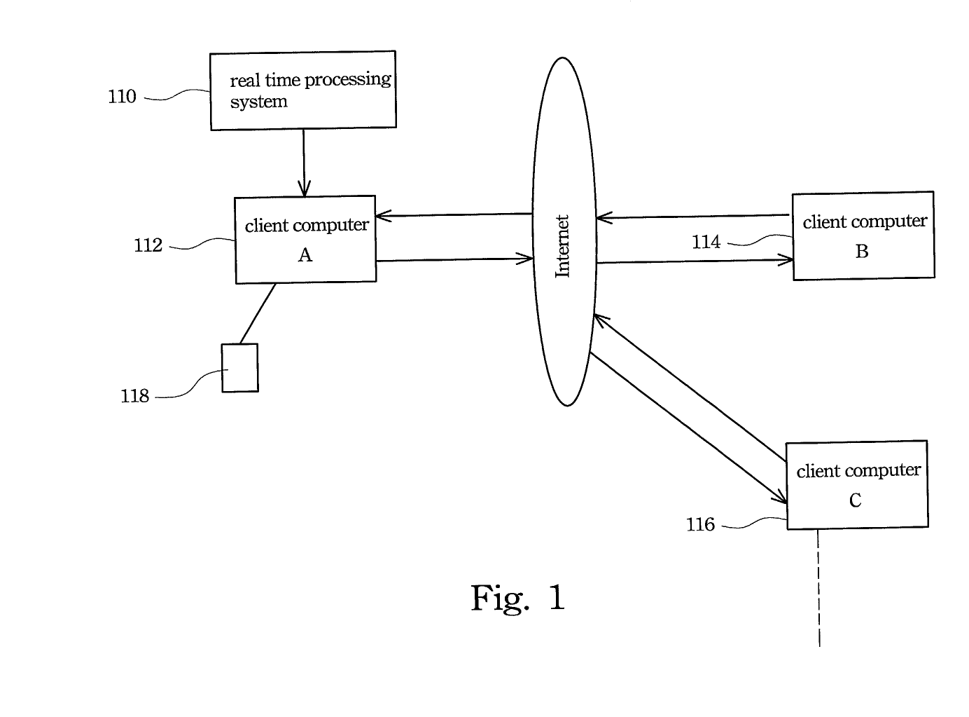

The present invention discloses a method and system of real time process message and to remind users automatically. FIG. 1 is a block diagram illustrating a real time processing system of the present invention. The real time processing system consists of client computer A 112 having a real time processing system 110 according to the present invention, client computer B 114 and client computer C 116,etc.. These client computers may send and receive e-mails and process them on-line by talking to each other through the Internet. In accordance with the present invention's real time processing system 110, users may set the trigger event to start system 110 to remind themselves through the computer when a specific event happens. For example, the specific e-mail the user is waiting for is received by the e-mail management system, the specific person the user wants to talk to is online, and the specific time of the meeting is stated, etc. In accordance with the example of receiving the specific e-mail, the client, computer A 112 is linked to the Internet to receive the e-mail coming from the other client's computer through the e-mail server (not shown in the figure). Suppose client computer A 112 sets the real time processing system 110 to send out a reminding signal when receiving the e-mail coming from client computer B 114. At this point, any e-mail received by client computer A 112 will be checked by the real time processing system 110. If the checked e-mail is from client computer B 114, the real time processing system 110 may send out a predetermined reminding signal. The reminding signal may utilize shaking of the mouse, sending out a voice or light or displaying an image on the screen to remind the user. If the e-mail the user wants to receive contains personal information, the user may choose to use the shaking of the mouse or sending out the reminding light as the reminding method to keep information private. Then, real time processing system 110, according to the present invention, will send out a signal to drive a mouse 118 to have the mouse shake or shine to remind the users.

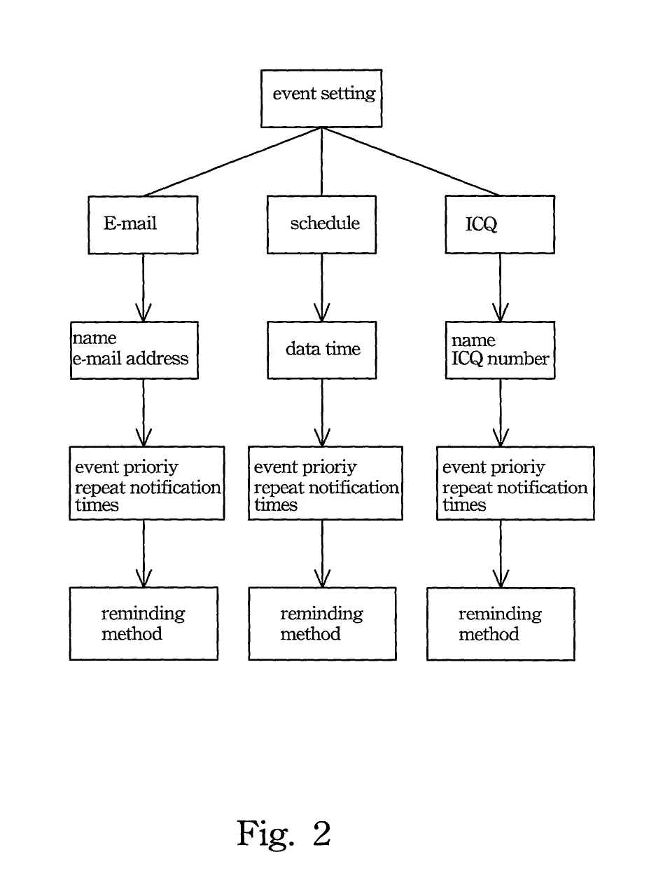

FIG. 2 is a flow chart illustrating the setting event process of real time processing system 110 according to the present invention. In accordance with the preferred embodiment, real time processing system 110 provides the users a way to set three kinds of specific events including the specific e-mail, the specific time on the schedule and the specific person they want to communicate with by ICQ. Another specific event which can be sent through the Internet or be triggered by a counter in a computer can also be set.

In the e-mail setting process, first, the name and address of the senders that the users want to receive mail from are set, wherein the name and address can be arranged more than one at one time. When the name of the sender or e-mail addresses are checked by real time processing system 110, system 110 will send out a reminding signal to users and show the name of the sender on the screen. Then, the users set the number of times they want the reminder repeated and event priority, wherein the event priority may remind the users the importance of this e-mail and the number of times it will be repeated to avoid users forgetting to check their mail once they have been alerted. Then, reminding method must be set, real time processing system 110, according to the present invention, may provide the users many kinds of reminding ways. The users may also set the notification message which may be shown on the screen following the reminder message to tell the users that the waited for e-mail has been received. It will also show the person who sent the e-mail. Real time processing system 110 will utilize a send out voice, shining or image to remind the users. If the e-mail the user wants to receive contains personal and/or confidential information, the users may use shaking of the mouse or sending out the reminding light as the reminding method to keep any information they regard private.. Then, real time processing system 110 according to the present invention will send out a signal to drive a mouse 118, having the function of shaking or shining to remind the users. The above reminding method also can be combined.

In accordance with the schedule event setting process, first, the data and the time that the users want to be reminded are set, wherein the data and the time can be arranged for more than one at one time. When the data and time are checked by real time processing system 110, system 110 will send out a reminding signal to the users and then show the contents of the schedule on the screen. Then, the users set the repeat reminder times and schedule event priority, wherein the event priority may remind the users of the importance this scheduled event has. The repeat reminder times may be repeated to remind the users not to forget to check their mail once they have been alerted. Users should set the reminding method next. Real time processing system 110, according to the present invention, may provide users with many kinds of reminding methods and the users may also set the notification message which can be shown on the screen following the reminder to tell users that the contents of the schedule. Real time processing system 110 will utilize send out voice, shining or images to remind the users. If the schedule content contains personal and/or confidential information, the users may use shaking of the mouse or sending out the reminding light as the reminding method to keep this information secret, wherein the reminding method also can be combined together.

In accordance with the ICQ event setting process, first, the name and ICQ number the users wants to be reminded of are set, wherein the name and the ICQ number can be arranged more than one at one time. When the name and ICQ number are checked by real time processing system 110, system 110 will send out a reminding signal to the users and show the name on the screen. Then, the users set the repeat reminder times and event priority, wherein the event priority may remind the users the importance of the event that will be talked about on line. Repeat reminder times may be repeated to remind the users not to forget to check their mail once they have been alerted.. Then set the reminding method, real time processing system 110, according to the present invention, may provide the users many kinds of reminding methods and the users may also set the notification message which may be shown on the screen following the reminder to tell the users who is on line. Real time processing system 110 will utilize send out voice, shining or images to remind the users. The users may use shaking of the mouse or sending out the reminding light as the reminding method to keep this secret, wherein the reminding method also can be combined together.

Referring to the flow chart found in FIG. 2A, it illustrates the setting process of hot key of the present invention. After receiving the reminding signal, and having already set the hot key function, users may quickly enter the e-mail management system to receive the e-mail, enter the ICQ application system to request an online chat, or enter the schedule management system to check the schedule, etc. However, the hot key may also be set to connect with a specific web site.

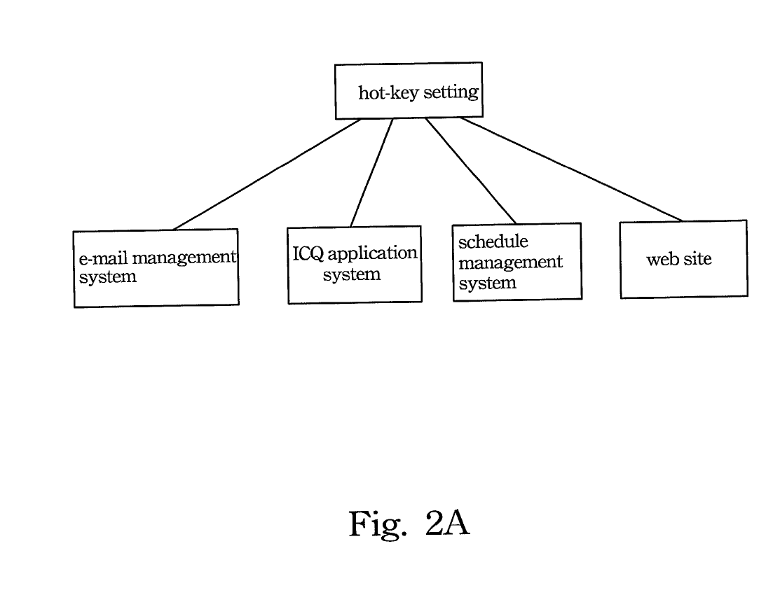

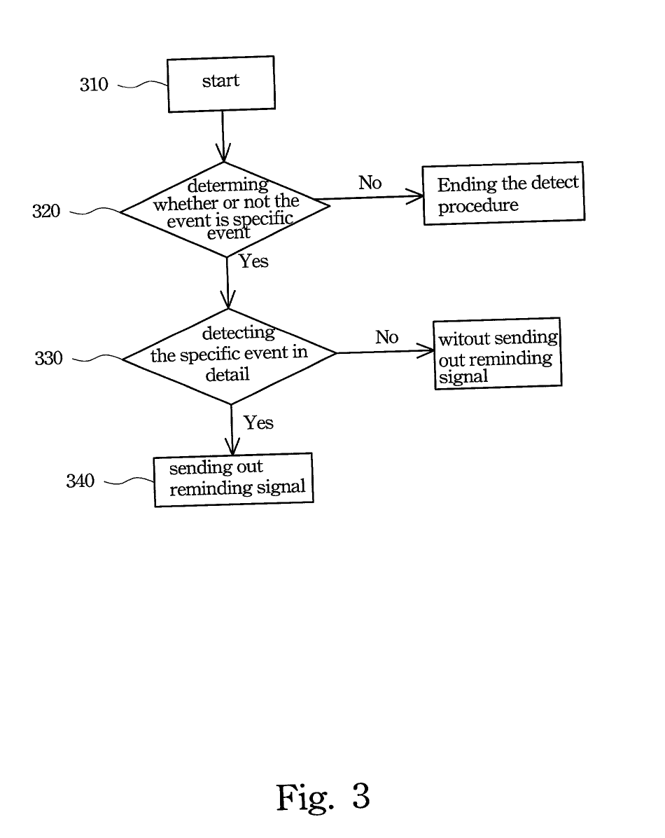

In FIG. 3 a flow chart is shown illustrating the checking event process of the present invention. The flow chart begins at step 310. At step 320, when real time processing system detects an event, the system may check the event to determine whether or not the detected event is the predetermined or specific event. In accordance with the prefer embodiment, the specific event is e-mail, ICQ, and schedule. The procedure will enter the next step if the predetermined or specific event is detected, otherwise, the real time processing system will stop the detection procedure. Next, the real time processing system will detect the specific event in detail at step 330. For example, if the specific event is e-mail, the e-mail address or sender's name will be detected at step 330 to determine whether or not the e-mail address and name have been predetermined. If they are, the real time processing system will use the predetermined reminding method, such as shaking, shining, sending out voice or images or a combination of them in order to remind the users, otherwise, the real time processing system may not send out any reminding signal. At this point, the display will also show the reminder screen to notify the users who the sender is and the e-mail priority. The reminder screen is shown in FIG. 4. Then, users may utilize the predetermined hot key to enter the e-mail management system to check the contents of this e-mail.

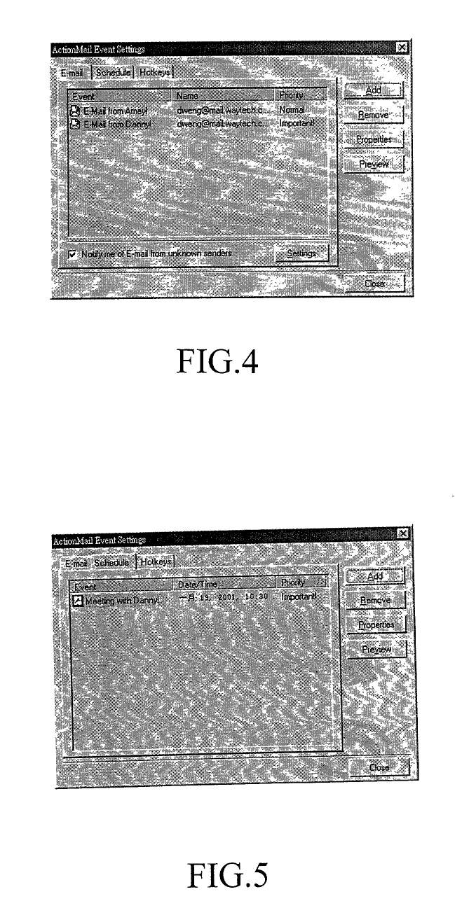

If the specific event is a scheduled event, the time of the schedule will be detected at step 330. If the counter in the computer counts the predetermined time of the schedule, the real time processing system will use the predetermined reminding method, such as shaking, shining, sending out voice or images or a combination of them, to remind the users, otherwise, the real time processing system may not send out any reminding signal. At this point, the display will also show the reminder screen to notify users the subject of the schedule and this schedule priority. The reminding screen is shown in FIG. 5. Then, the users may utilize the predetermined hot key to check the schedule in detail by entering the schedule management system.

Although the invention has been described in detail herein, with reference to its preferred embodiment, it is to be understood that this description is by way of example only, and is not to be interpreted in a limiting sense. It is to be further understood that numerous changes in the details of the embodiments of the invention can occur, and additional embodiments of the invention, will be apparent, and may be made by, persons of ordinary skill in the art having reference to this description. It is considered that such changes and additional embodiments are within the spirit and true scope of the invention as claimed below.

We claim:

1. A computer implemented method for real time processing message,which comprises the step of:
receiving a specific event from a computer or the Internet;
comparing the contents of said specific event with a predetermined data stored in a real time processing system; and
sending out a reminding signal and showing a reminder screen on the display if said contents of said specific event match said data stored in said real time processing system.

2. The method of claim 1, wherein said specific event further includes an event selected from a group consists of e-mail, schedule and ICQ.

3. The method of claim 1, wherein said contents of said specific event includes a name, email address, scheduled time, and the address that may be transmitted through the Internet.

4. The method of claim 1, wherein said predetermined data stored in the real time processing system includes name, email address, scheduled time, and the address that may be transmitted through the Internet.

5. The method of claim 1, wherein said reminding signal includes shaking, shining, images and sending out voice.

6. The method of claim 1, wherein the users may use the hot key to enter said specific event when receiving said reminding signal of said specific event.

7. The method of claim 1, wherein said showing reminding screen includes showing the subject of said specific event.

8. A computer implemented method for real time reminding, the method is comprised of:
receiving a specific event from a computer or the Internet;
comparing the contents of said specific event with a predetermined data stored in a real time processing system; and
sending out a shaking, shining or voice signal and showing a reminder screen on the display if said contents of said specific event match said data stored in said real time processing system.

9. The method of claim 8, wherein said specific event further includes an event selected from a group consisting of e-mail, schedule, and ICQ.

10. The method of claim 8, wherein said contents of said specific event includes name, email address, scheduled, time and the address that may be transmitted through the Internet.

11. The method of claim 8, wherein said predetermined data stored in said real time processing system includes name, email address, scheduled time, and the address that may be transmitted through the Internet.

12. The method of claim 8, wherein the users may use the hot key to enter said specific event when receiving said reminding signal of said specific event.

13. The method of claim 8, wherein said showing reminding screen includes showing the subject of said specific event.

14. The method of claim 8, wherein said sending out of a shaking, shining or voice signal may be reached by driving a mouse.

15. A computer implemented system for real time reminding comprising:
a receiver, receiving a specific event from a computer or the Internet;
a comparator, comparing the contents of said specific event with a predetermined data stored in a real time processing system; and
an apparatus which can send out a shaking, shining or voice signal, if said contents of said specific event match said data stored in said real time processing system, said real time processing system may drive said apparatus and show the reminder screen on the display.

16. The system of claim 15, wherein said specific event further includes an event selected from a group that consists of e-mail, schedule, and ICQ.

17. The system of claim 15, wherein said contents of said specific event includes name, email address, scheduled time, and the address that may be transmitted through the Internet.

18. The system of claim 15, wherein said predetermined data stored in the real time processing system includes name, email address, scheduled time, and the address that may be transmitted through the Internet.

19. The system of claim 15, wherein the users may use the hot key to enter the said specific event when receiving said reminding signal of said specific event.

20. The system of claim 15, wherein the said show reminding screen includes showing the subject of said specific event.

21. The system of claim 15, wherein said apparatus includes a mouse.
